(19) United States
(12) Patent Application Publication
(10) Pub. No.: US 2008/0123198 A1
(43) Pub. Date: May 29, 2008

(54) Optical Coupler

(75) Inventor: Hideaki Fujita, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/795,332

(22) PCT Filed: Jan. 13, 2006
(86) PCT No.: PCT/JP06/00350

§ 371 Date: Jul. 16, 2007

(30) Foreign Application Priority Data
Jan. 18, 2005 (JP) 2005-009991

(51) Int. Cl. G02B 6/42

(52) U.S. Cl. 359/709; 359/820

(57) ABSTRACT

A lens member (55) is made to adhere to a lead frame (36) via a transparent adhesive resin (41) and is not transfer molded with a sealing body (37). With this arrangement, the transparent adhesive resin (41) can be used as a member for buffering a thermal stress due to a linear expansion coefficient difference between the lead frame (36) and the lens member (55). By using a resin of a low Young's modulus such as a silicon based resin, the damage and deformation of the lens member (55) can be prevented by largely reducing the thermal stress exerted on the lens member (55). Furthermore, the linear expansion coefficient can be reduced by adding filler to the sealing body (37), and the optical coupler can be used under an environment of a wide temperature range of, for example, −40° C. to 115° C.

### TECHNICAL FIELD

The present invention relates to an optical coupler that has an optical element and, in particular, to an optical coupler that can be used for domestic communications, car onboard communications, LAN (Local Area Network) and so on by using an optical fiber as a transmission medium.

### BACKGROUND ART

Conventionally, an optical coupler, in which an optical element such as a light emitting diode (LED) or a photodiode (PD) is optically coupled with an optical fiber, has been known and utilized for optical communications between devices, in a home or a car or the like. In general, known optical couplers include one in which an optical element is sealed (transfer molded) with a transparent mold resin and one in which an optical element is air tightly sealed (hermetically sealed) in a metallic casing.

FIG. 9 shows a longitudinal sectional view of an optical coupler 1 as a first prior art. In the optical coupler 1, an optical element 3 is mounted on a lead frame 2, and the optical element 3 is transfer molded with a transparent mold resin 4. A lens portion 6 is formed in a position facing an optical surface (on and from which light is incident and emitted) 5 of the optical element 3 at the transparent mold resin 4. Moreover, the optical element 3 and a lead frame 2 are electrically connected together via a bonding wire 8.

In the optical coupler 1 of the above construction, when the optical element 3 is a light emitting element, light emitted from the optical surface 5 passes through the inside of the transparent mold resin 4 and is condensed by the lens portion 6 and emitted toward an end surface 7a of an optical fiber 7. Then, the light thus emitted from the lens portion 6 is incident on the optical fiber 7.

Moreover, when the optical element 3 is a light receiving element, light emitted from the end surface 7a of the optical fiber 7 is condensed by the lens portion 6 of the transparent mold resin 4, transmitted through the inside of the transparent mold resin 4 and made incident on the optical surface 5. Thus, the optical fiber 7 and the optical element 3 are so-called optically coupled with each other into a state in which they can exchange optical communications.

FIG. 10 shows a longitudinal sectional view of an optical coupler 11 as a second prior art (first patent document (JP S60-12782 A (FIG. 3))). In the optical coupler 11, an optical element 12 is placed in a position of a through hole 15 at a surface (hereinafter referred to as a lower surface) 13a opposite from the optical fiber 14 side of a lead frame 13 and transfer molded with a transparent mold resin 16.

In the optical coupler 11 of the above construction, light emitted from the optical surface 17 of the optical element 12 passes through the through hole 15 and is transmitted through the transparent mold resin 16 and made incident on an end surface 14a of an optical fiber 14 or light emitted from the end surface 14a of the optical fiber 14 is incident on the optical surface 17 via the reverse path.

In the optical coupler 11 as described above, a bonding wire 18 that electrically connects the optical element 12 with the lead frame 13 can be placed on the lower surface 13a side of the lead frame 13. Therefore, an interval between the optical element 12 and the optical fiber 14 can be made narrower than in the case of the optical coupler 1 (i.e., the thickness of the transparent mold resin 16 can be made thinner on the optical fiber 14 side), and there is an effect of improving the use efficiency of light when a light emitting element of a large angle of radiation such as an LED is used as the optical element 12.

FIG. 11 shows a longitudinal sectional view of an optical coupler 21 as a third prior art (second patent document (JP S59-180515 A (FIG. 2))). In the optical coupler 21, an optical element 22 is placed at a bottom portion of a recess 23a of a metallic stem 23 and is hermetically sealed with a lens cap 25 provided with a lens 24. The optical element 22 and a lead terminal 26 are electrically connected together via a bonding wire 27.

In the optical coupler 21 of the above construction, light emitted from the optical element 22 is condensed by the lens 24 of the lens cap 25 and made incident on an end surface 28a of an optical fiber 28 or light emitted from the end surface 28a of the optical fiber 28 is incident on the optical element 22 via the reverse path.

However, the conventional optical couplers have problems as follows. That is, the first and second prior arts have the constructions in which the optical elements 3, 12 are placed on the lead frames 2, 13 and sealed with the transparent mold resins 4 and 16. In this case, linear expansion coefficient differences between the transparent mold resins 4, 16 and the lead frames 2, 13 are large, and this therefore leads to a problem that the ambient temperature at which the optical couplers 1, 11 can be used is limited.

That is, in the first prior art, the linear expansion coefficient of the epoxy based resin used as the transparent mold resin 4 is generally 60 ppm/K to 70 ppm/K. In contrast to this, the linear expansion coefficient of copper or the like used for the lead frame 2 is about 20 ppm/K. Since the linear expansion coefficient difference is large, a large thermal stress is generated at the interface between the transparent mold resin 4 and the lead frame 2 when the ambient temperature changes. This therefore leads to a problem that the transparent mold resin 4 is broken (cracked), a problem that the transparent mold resin 4 peels off the lead frame 2, and a problem that the lens portion 6 is deformed to change the optical characteristics, and so on.

Moreover, the second prior art has a problem that the transparent mold resin 16 entering the through hole 15 of the lead frame 13 peels off the surface of the optical element 12 by a thermal stress, and the characteristics of the optical element 12 change (e.g., when the optical element 12 is an LED, the optical extraction efficiency changes as a consequence of a change in the refractive index of a surface of the optical surface 17 put in contact with the optical element 12 due to the peeling-off of the transparent mold resin 16). On the other hand, it is known that the linear expansion coefficient can be reduced by adding filler to the mold resin. In this case, the transparent mold resin 16 disadvantageously becomes turbid in white, and the optical characteristics become deteriorated (transmittance is reduced). Therefore, it is difficult to use the filler-added resin for the optical coupler 11. For the above reasons, the use ambient temperature of the optical coupler 11 is limited to a range of about −20° C. to 80° C.

Moreover, the third prior art uses the hermetic seal as described above. In the case, there are the problems that the optical coupler 21 becomes expensive due to the use of the metallic stem 23 and has difficulties in being reduced in size although the influence of the thermal stress as described in connection with the second prior art is small. There is another problem that the reflection loss of light is large due to an air layer formed in between the optical element 22 and the lens cap 25.

Patent Document 1: JP S60-12782 A (FIG. 3)

Patent Document 2: JP S59-180515 A (FIG. 2)

### DISCLOSURE OF THE INVENTION

It is an object of the present invention to provide a compact low-cost optical coupler, which has a wide usable ambient temperature range and is able to obtain stable optical characteristics.

In order to achieve the above object, there is provided an optical coupler comprising:

an optical element;

a lead frame on which the optical element is mounted and which is electrically connected to the optical element; and

a lens member including a lens that condenses light that is incident on or emitted from the optical element, wherein

the lens of the lens member is placed facing an optical surface, on or from which light is incident or emitted, of the optical element, and

a transparent resin is interposed between the lens member and the optical surface of the optical element.

According to the above construction, a lens of a size smaller than the lens that is formed by transfer molding and concurrently serves as a seal as in the optical coupler 1 of the first prior art can be employed, and the thermal stress exerted on the lens member can be reduced. This therefore makes it difficult to deform or damage the lens member and to cause peeling-off of the lead frame. Furthermore, the transparent resin can be used as a member for buffering the thermal stress generated in between the lead frame and the lens member due to a linear expansion coefficient difference between the lead frame and the lens member. Therefore, it becomes possible to use the optical coupler within a wide temperature range. Furthermore, since the transparent resin is interposed between the lens member and the optical surface of the optical element, the optical surface of the optical element can be protected.

In one embodiment of the invention, the transparent resin also extends over a surface of the lead frame located on a side on which the lens member is placed, and the lens member is made to adhere to the lead frame via the transparent resin that extends over the surface of the lead frame and is not put in direct contact with the lead frame.

According to the present embodiment, since the lens member is not put in direct contact with the lead frame, the effect of buffering the thermal stress due to the transparent resin is improved, and the thermal stress exerted on the lens member can reliably be reduced.

In one embodiment of the invention, the transparent resin has a Young's modulus of not greater than 1 GPa.

According to the present embodiment, by using a resin having a Young's modulus of not greater than 1 GPa as the transparent resin, the transparent resin can function as a better member for buffering the thermal stress that takes effect between the lens member and the lead frame. Therefore, the optical coupler can be used within a wider temperature range.

In one embodiment of the invention, the transparent resin is a silicon based compound.

According to the present embodiment, the silicon based compound is used as the transparent resin, both the effect of buffering the thermal stress and the effect of sealing the optical element described above can be obtained.

In one embodiment of the invention, a portion excluding at least the lens member and the transparent resin is sealed with a filler-added resin.

According to the present embodiment, by virtue of the sealing with the filler-added resin of which the linear expansion coefficient is close to that of the lead frame, the optical element, the bonding wire and so on, the influence of the thermal stress exerted on the lead frame, the optical element and so on is reduced. Therefore, the optical coupler can be used within a wider temperature range.

In one embodiment of the invention, a resin reservoir portion, which prevents the transparent resin put in between the lens member and the optical surface of the optical element from expanding beyond a region of the lens member, is provided at the filler-added resin.

According to the present embodiment, the uncured liquid transparent resin put in between the lens member and the optical surface of the optical element can be prevented from flowing to the outside beyond the region of the lens member. Therefore, manufacturing becomes easy, and it becomes possible to make the lens member adhere to the lead frame in a state in which the lens member is separated from the lead frame by the transparent resin stored in the resin reservoir portion. Furthermore, the parts count can be reduced by forming the resin reservoir portion of the filler-added resin.

In one embodiment of the invention, the resin reservoir portion is comprised of a recess, which has a planar shape roughly identical to a planar shape of the lens member and in which the lens member is accommodated, and a connector portion, in which a tip end portion of an optical fiber for transmitting light that is incident on or emitted from the optical element is fit and which performs positional alignment between the tip end portion of the fit optical fiber and the lens member is provided at a periphery of an opening of the resin reservoir portion.

According to the present embodiment, a size reduction can be achieved since the resin reservoir portion and the connector portion are integrally formed of the filler-added resin. Furthermore, the connector portion in which the tip end portion of the optical fiber is fit is provided at the periphery of the opening in the resin reservoir portion constructed of the recess that accommodates the lens member. Therefore, only by fitting the tip end portion of the optical fiber in the connector portion, positional alignment of the lens member with the tip end portion of the optical fiber can be achieved simply with high accuracy.

In one embodiment of the invention, a through hole is formed at the lead frame, the optical element is placed so that the optical surface is located in the through hole formed at the lead frame, and one opening of the through hole is closed, the lens member is placed so that an optical axis of the lens penetrates inside of the through hole formed at the lead frame, and the other opening of the through hole is closed, and the through hole is filled with the transparent resin.

According to the present embodiment, the lead frame can be used as a lens barrel of the lens, and it becomes possible to reduce the size of the optical coupler and to reduce the cost with reduced parts count. Furthermore, since the through hole of the lead frame is filled with the transparent resin, the optical surface of the optical element located just below the through hole can be protected.

In one embodiment of the invention, a projection, which is inserted in the through hole of the lead frame when placed so that the lens member is located to close the other opening of the through hole of the lead frame, is provided on a surface, which faces the lead frame, of the lens member.

According to the present embodiment, the projection of the lens member is inserted in the through hole when the lens member is placed to close the other opening of the through hole of the lead frame. Therefore, the uncured liquid transparent resin put in the through hole is pushed out of the through hole together with air bubbles. Therefore, air bubbles can be prevented from entering the cured transparent resin in the through hole, and the manufacturing variation of the optical characteristics can be reduced.

In one embodiment of the invention, the projection of the lens member has a taper shape whose dimension in a direction perpendicular to the optical axis is reduced toward the tip end.

According to the present embodiment, since the projection of the lens member is formed into a taper shape, the liquid transparent resin in the through hole of the lead frame is continuously pushed out by the projection of the taper shape. Therefore, air bubbles can more reliably be prevented from entering the cured transparent resin in the through hole, and the manufacturing variation of the optical characteristics can further be reduced.

In one embodiment of the invention, a groove portion, which communicates with the through hole of the lead frame and the outside is provided on a surface, which faces the lead frame, of the lens member.

According to the present embodiment, the groove portion that communicates with the through hole of the lead frame and the outside is formed at the lens member. Therefore, when the lens member is placed to close the other opening of the through hole of the lead frame, the uncured liquid transparent resin put in the through hole flows to the outside together with air bubbles via the groove portion. Therefore, air bubbles can be prevented from entering the cured transparent resin in the through hole, and the manufacturing variation of the optical characteristics can be reduced.

In one embodiment of the invention, an inner peripheral surface of the through hole of the lead frame (36) is a reflecting surface for reflecting light that is incident on or emitted from the optical element.

According to the present embodiment, by using the inner peripheral surface of the through hole of the lead frame as a reflecting surface, the through hole of the lead frame can be utilized as an optical path changing member, and the optical functions of an improvement in the optical coupling efficiency and so on can be added.

As is apparent from the above, in the optical coupler of the present invention, the lens member is placed facing the optical surface of the optical element, and the transparent resin is interposed between the lens member and the optical surface of the optical element. Therefore, a lens of a size smaller than the lens formed by transfer molding for sealing the element can be employed, and the thermal stress exerted on the lens member can be reduced. This therefore makes it difficult to deform or damage the lens member and to cause peeling-off of the lead frame.

Furthermore, the transparent resin can be used as a member for buffering the thermal stress generated in between the lead frame and the lens member due to a linear expansion coefficient difference between the lead frame and the lens member. Therefore, it becomes possible to use the optical coupler within a wide temperature range. Furthermore, since the transparent resin is interposed between the lens member and the optical surface of the optical element, the optical surface of the optical element can be protected.

Moreover, in the optical coupler of one embodiment, the through hole is formed at the lead frame, the lens member is placed so that the optical axis of the lens penetrates the through hole formed at the lead frame and the opening of the through hole is closed, and the through hole is internally filled with the transparent resin. Therefore, the lead frame can be used as a lens barrel of the lens, and the optical coupler can be reduced in size, so that the cost can be reduced with reduced parts count. Furthermore, since the through hole of the lead frame is filled with the transparent resin, the optical surface of the optical element located just below the through hole can be protected.

Moreover, in the optical coupler of one embodiment, the projection to be inserted in the through hole of the lead frame is provided for the lens member. Therefore, the uncured liquid transparent resin put in the through hole can be pushed out of the through hole together with air bubbles when the projection of the lens member is inserted in the through hole. Therefore, air bubbles can be prevented from entering the cured transparent resin in the through hole, and the manufacturing variation of the optical characteristics can be reduced.

### BRIEF DESCRIPTION OF THE DRAWINGS

FIG. 1 is a longitudinal sectional view of a first embodiment of the optical coupler of the present invention;

FIG. 2 is a longitudinal sectional view of a second embodiment;

FIG. 3A is a longitudinal sectional view showing a procedure for manufacturing the optical coupler shown in FIG. 2;

FIG. 3B is a longitudinal sectional view showing a procedure for manufacturing the optical coupler continued from FIG. 3A;

FIG. 3C is a longitudinal sectional view showing a procedure for manufacturing the optical coupler continued from FIG. 3B;

FIG. 3D is a longitudinal sectional view showing a procedure for manufacturing the optical coupler continued from FIG. 3C;

FIG. 4A is a plan view of the optical coupler shown in FIG. 2;

FIG. 4B is a longitudinal sectional view of the optical coupler shown in FIG. 2;

FIG. 4C is a bottom view of the optical coupler shown in FIG. 2;

FIG. 5 is a view showing a modification example of the optical coupler shown in FIG. 2;

FIG. 6 is a view showing a modification example different from FIG. 5;

FIG. 7 is a view showing a modification example different from FIG. 5 and FIG. 6;

FIG. 8 is a view showing a modification example different from FIGS. 5-7;

FIG. 9 is a longitudinal sectional view of a conventional optical coupler;

FIG. 10 is a longitudinal sectional view of a conventional optical coupler different from FIG. 9; and

FIG. 11 is a longitudinal sectional view of a conventional optical coupler different from FIG. 9 and FIG. 10.

### REFERENCE NUMERAL

30, 31, 61, 71, 81, 91 . . . optical coupler
32 . . . optical element
33 . . . optical fiber
34 . . . plug
35 . . . connector portion
36, 92 . . . lead frame
37, 94 . . . sealing body
38, 55, 82 . . . lens member
39 . . . drive circuit
40, 40a, 40b . . . bonding wire
41 . . . transparent adhesive resin
45, 62, 72, 95 . . . through hole
46 . . . optical surface
47, 56 . . . lens portion
48 . . . projection
49, 57 . . . adhesion portion
50, 58, 93 . . . resin reservoir portion
51 . . . resin outflow portion (groove portion)
52 . . . resin holding portion
59 . . . adhesive resin filling portion
63 . . . inner peripheral surface of a through hole
73 . . . submount
74 . . . optical passage portion

### DETAILED DESCRIPTION OF THE INVENTION

The present invention will now be described below with reference to the embodiments shown in the drawings.

### First Embodiment

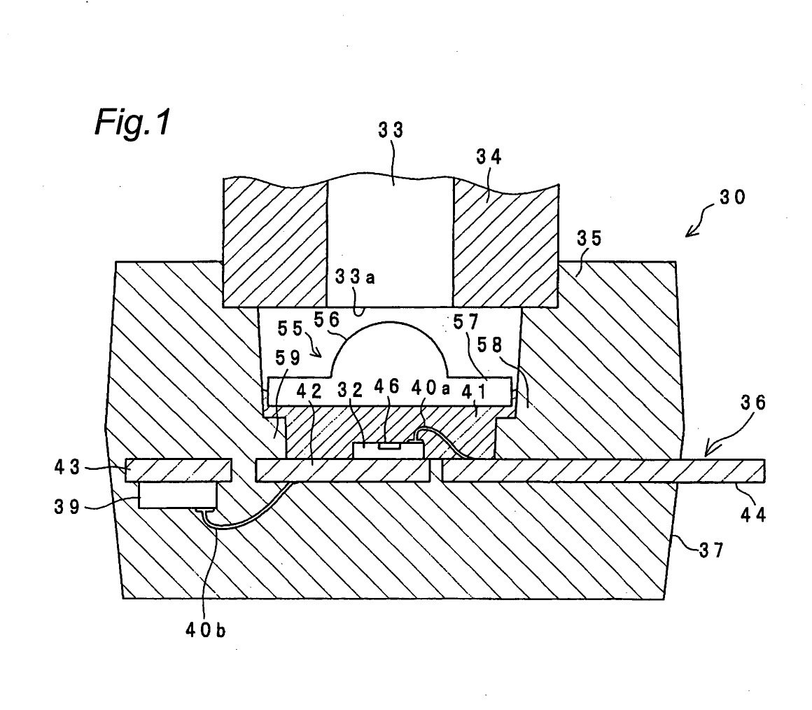

FIG. 1 is a longitudinal sectional view of the optical coupler of the present embodiment. The optical coupler 30 is a device for connecting an optical element 32 to an optical fiber 33 in an optically transmittable state (so-called optically coupled state) in order to carry out optical communications. The optical element 32 is a semiconductor that has an optical function and is provided by, for example, a light emitting element such as a light emitting diode or a vertical-cavity surface-emitting laser (VCSEL) or a light receiving element such as a photodiode.

The optical fiber 33 is a cable formed in an elongated shape with flexibility and serves as a light transmitting medium that transmits light from one end portion to the other end portion. That is, light incident from one end portion of the optical fiber 33 passes through the inside of the optical fiber 33 and is emitted from the other end portion of the optical fiber 33. The one end portion of the optical fiber 33 is peripherally covered with a plug 34 that is a coupling portion for coupling with the optical coupler 30.

The optical coupler 30 has a connector portion 35 in which the plug 34 of the optical fiber 33 is detachably fit. Then, in a state in which the plug 34 is fit in the connector portion 35, one end surface 33a of the optical fiber 33 is placed in a position opposite to the optical element 32. That is, when the plug 34 is connected to the connector portion 35, the optical fiber 33 is automatically adjusted in position with respect to the optical element 32.

As shown in FIG. 1, the optical coupler 30 is constituted by including the optical element 32, a lead frame 36, a sealing body 37, a lens member 55, a drive circuit 39, a bonding wire 40 and a transparent adhesive resin 41. Further, the lead frame 36 is constituted of a plate-shaped member that has a thickness of about 100 μm to 500 μm and conductivity by including an optical element mounting portion 42, an internal connection portion 43 and an external connection portion 44.

The optical element 32 is placed so as to be located on a surface (hereinafter referred to as an “upper surface”) on the optical fiber 33 side of the lead frame 36 so that an optical surface 46 is located at the center of the optical fiber 33. The surface of the lead frame 36 on the side of which the optical fiber 33 is not placed is hereinafter referred to as a “lower surface”. The optical element mounting portion 42 is electrically connected to the drive circuit 39 of the internal connection portion 43 via a bonding wire 40b. Moreover, the optical element 32 is electrically connected to the external connection portion 44 via a bonding wire 40a. Although other connections are actually provided via many bonding wires, the wires are not shown in FIG. 1. It is noted that the bonding wire 40a represents the bonding wires in the portions filled with the transparent adhesive resin 41, and the bonding wire 40b represents the bonding wires in the portions sealed with the sealing body 37.

The lens member 55 is placed facing the optical element 32 on the upper surface side of the optical element mounting portion 42 of the lead frame 36. The lens member 55 is constructed of a lens portion 56 that condenses light that is made incident on and emitted from the optical surface 46 of the optical element 32, and an adhesion portion 57 facing the upper surface of the lead frame 36. Then, a space between the lens member 55 and the lead frame 36 is filled with the transparent adhesive resin 41. Thus, the transparent adhesive resin 41 is put in contact with the upper surface of the lead frame 36 and the optical surface 46 of the optical element 32 and further in contact with the adhesion portion 57 of the lens member 55. That is, the optical surface 46 of the optical element 32 and the lens member 55 adhere together via the transparent adhesive resin 41.

The lead frame 36 is peripherally sealed (transfer molded) with the sealing body 37 excluding the surroundings of the optical element 32 on the upper surface thereof. Thus, the sealing body 37 seals and protects the drive circuit 39, the bonding wire 40b and so on. Moreover, in the present embodiment, the connector portion 35 described above is formed of the sealing body 37.

Further, a resin reservoir portion 58 is formed in a lower portion of the connector portion 35 of the sealing body 37. The resin reservoir portion 58 has a planar shape roughly identical to the planar shape of the lens member 55 and is constructed of a hole portion in which the lens member 55 is accommodated. Further, an adhesive resin filling portion 59 constructed of a recess that has a planar shape obtained by contracting the planar shape of the lens member 55 is formed via a step portion in the lower portion of the resin reservoir portion 58. Then, the resin reservoir portion 58 plays the role of preventing the liquid transparent adhesive resin 41 put in the adhesive resin filling portion 59 by means of a dispenser or the like from overflowing from the adhesive resin filling portion 59 and from flowing to the outside beyond the region of the lens member 55. The adhesive resin filling portion 59 is filled with the transparent adhesive resin 41 and further has the role of separating the lens member 55 from the upper surface of the lead frame 36 by the step portion and allowing the lens member 55 to be placed without being obstructed by the optical element 32 and the bonding wire 40a.

Moreover, the resin reservoir portion 58 can be utilized for positional alignment between the lens member 55 and the optical element mounting portion 42. That is, by making the resin reservoir portion 58 have a planar shape roughly identical to the planar shape of the lens member 55 and making the inside diameter of the resin reservoir portion 58 roughly equivalent to the outside diameter of the adhesion portion 57 of the lens member 55, the positional alignment can be achieved. Moreover, in the present construction, the connector portion 35, which is constructed of a step portion in which the plug 34 of the optical fiber 33 is fit and performs positional alignment between the one end surface 33a of the fit optical fiber 33 and the lens portion 56, is formed at the periphery of the opening of the resin reservoir portion 58. Therefore, the positional alignment of the optical fiber 33 and the positional alignment of the lens member 55 can be achieved by the identical member, so that high-accuracy simple assembling can be achieved.

The present optical coupler 30 is electrically connected to a controller (not shown) that is an external device so as to mutually transmit and receive an electrical signal. When the optical element 32 is a light emitting element, the controller supplies a light emission command as the electrical signal to the drive circuit 39. Then, the drive circuit 39 makes the optical surface 46 of the light emitting element (optical element) 32 emit light according to the supplied light emission command (electrical signal). Then, the light emitted from the optical surface 46 is made incident on the lens member 55, condensed by the lens portion 56 and made incident on the one end surface 33a of the optical fiber 33.

When the optical element 32 is a light receiving element, light emitted from the one end surface 33a of the optical fiber 33 is made incident on the lens member 55, condensed by the lens portion 56 and made incident on the optical surface 46 of the light receiving element (optical element) 32. Then, the light receiving element 32 generates an electrical signal (e.g., voltage signal) corresponding to the light (e.g., quantity of light) incident on the optical surface 46 and outputs the generated electrical signal to the drive circuit 39 or the controller.

As described above, the present optical coupler 30 transmittably couples the optical element 32 with the optical fiber 33 and converts the electrical signal supplied from the controller into an optical signal, allowing the optical signal to be emitted from the optical element 32. Otherwise, the optical coupler converts the optical signal incident on the optical element 32 into an electrical signal, allowing the electrical signal to be outputted to the controller.

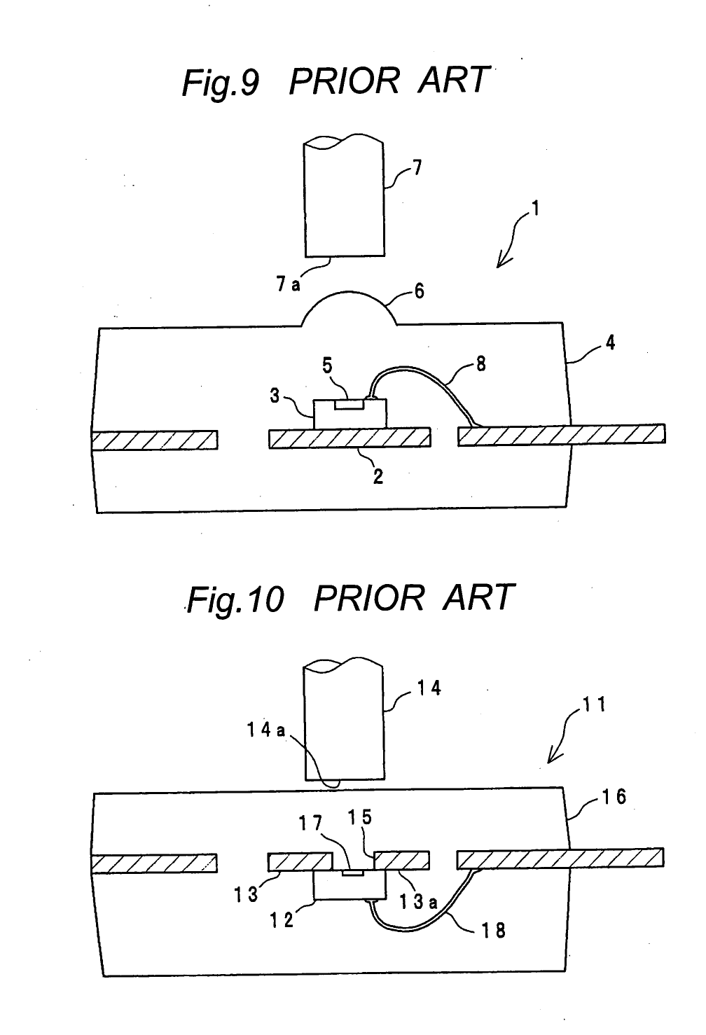

The reason why the influence of the thermal stress due to a change in the ambient temperature can be reduced in the present embodiment is described next by comparison to the first prior art (see FIG. 9) and the second prior art (see FIG. 10). Differences between the optical coupler 30 of the present embodiment and the optical couplers 1, 11 of the first and second prior arts reside mainly in the following three points. (A) A small-size lens member 55 can be used since the lens member 55 is not formed integrally with the sealing body 37 by transfer molding. (B) The lens member 55 is made to adhere to the lead frame 36 via the transparent adhesive resin 41. (C)

The upper surface of the optical surface 46 of the optical element 32 is sealed with the transparent adhesive resin 41. The following effects can be produced by the points of differences.

That is, in the conventional optical coupler 1 (see FIG. 9), the lens portion 6 is formed of the transparent mold resin 4, and the transparent mold resin 4 is a sealing body of members including the lead frame 2. In the above construction, the linear expansion coefficient difference between the lead frame 2 and the transparent mold resin 4 is large, and the thermal stress at the interface between both is increased. This therefore possibly causes damage (crack) of the transparent mold resin 4, peeling-off of the transparent mold resin 4 from the lead frame 2, and deformation of the lens portion 6.

In contrast to this, the lens member 55 (portion corresponding to the transparent mold resin 4 and the lens portion 6 of the optical coupler 1) is not necessarily formed by transfer molding or even when formed by transfer molding easily reduced in size in the present optical coupler 30. This allows the contact area of the sealing body 37 with the lead frame 36 to be reduced. Furthermore, since the lens member 55 is made to adhere to the lead frame 36 via the transparent adhesive resin 41, the transparent adhesive resin 41 can be utilized as a member for buffering the thermal stress due to the linear expansion coefficient difference between the lead frame 36 and the lens member 55. Therefore, the thermal stress exerted on the lens member 55 can largely be reduced, and the occurrence of damage and deformation in the lens member 55 can be prevented. In particular, the buffering effect of the transparent adhesive resin 41 is further increased by the use of a silicon based resin of a low Young's modulus as the transparent adhesive resin 41, and this is therefore preferable. Furthermore, the transparent adhesive resin 41 also makes it possible to reduce the stress exerted on the optical element 32 and the bonding wire 40a.

Moreover, as a secondary effect, the sealing body 37 (corresponding to the transparent mold resins 4, 16 of the optical couplers 1 and 11) is not required to have optical characteristics differently from the cases of the first and second prior arts, and therefore, a milk-white resin to which a filler such as silica is added or a black resin used for sealing an IC (Integrated Circuit) can be used. Therefore, since the milk-white or black resin is able to have a linear expansion coefficient equivalent to that of the lead frame 36 by adding the filler, the influence of the thermal stress can be reduced. That is, it becomes possible to reduce also the thermal stress exerted on the whole body of the optical coupler 30 and to reduce the stresses exerted on the sealing body 37, the bonding wire 40b and the drive circuit 39.

In contrast to this, the conventional optical coupler 11 (see FIG. 10) has a problem that the transparent mold resin 16 put in the through hole 15 peels off the surface of the optical element 12 by a thermal stress, changing the characteristics of the optical element 12. This is also ascribed to the fact that the contact area of the transparent mold resin 16 with the lead frame 13 is large and the thermal stress between the transparent mold resin 16 and the optical surface 17 is increased in the through hole 15.

The present optical coupler 30 is able to prevent the transparent adhesive resin 41 and the lens member 55 from peeling off the optical surface 46 because it has a stress buffering effect by using a resin of a low Young's modulus as the transparent adhesive resin 41, the transparent adhesive resin 41 is allowed to have an arbitrary material depending on the object to which it adheres, and a resin of a stronger adhesive power with respect to the lead frame 36 and the optical surface 46 than the transparent mold resin 16 that is generally used with transfer molding can be selected, and an optical coupler 30 of high reliability can be obtained.

The materials of the components are described in detail below.

First of all, it is possible for the lens member 55 to use a material of a resin such as polymethyl methacrylate (PMMA), polycarbonate or cycloolefin or a glass of a low melting point, the material processed into an arbitrary shape by injection molding or the like.

It is preferable for the transparent adhesive resin 41 to use a material that has excellent optical transparency and a refractive index close to that of the lens member 55 in order to reduce the reflection loss. Moreover, as described above, it is preferable to use a material that has a Young's modulus of not greater than 1 GPa in order to ease the thermal stress. In concrete, for example, an epoxy based resin, a silicon based resin or the like can be used. In particular, the silicon based resin is more preferable because it has a low Young's modulus, a high effect of easing the thermal stress as described above and a high effect of sealing the optical element 32.

It is general for the sealing body 37 to use a material that is obtained by adding a filler into an epoxy based resin or the like used for sealing a semiconductor element and has a linear expansion coefficient close to that of the bonding wire (Au or Al) 40b and a high thermal conductivity. For example, when the bonding wire 40b is Au whose linear expansion coefficient is 14.2 ppm/K, the linear expansion coefficient of the sealing body 37 should preferably be set to 20 ppm/K or less (linear expansion coefficient of the epoxy based resin to which no filler is added is normally about 60 ppm/K). Moreover, the thermal conductivity of the sealing body 37 should preferably be set to 0.6 W/m·K or more (thermal conductivity of the epoxy based resin to which no filler is added is normally about 0.2 W/m·K).

The optical element 32 may be a CCD (Charge Coupled Device), VCSEL (Vertical Cavity Surface Emitting Laser), an opto-electronic integrated circuit (OEIC) obtained by integrating the optical element 32 with an integrated circuit (IC) or the like besides LED and PD. The optical wavelength of the optical element 32 should preferably be a wavelength at which the transmission loss due to the optical fiber 33 coupled with the present optical coupler 30 is a little.

Moreover, it is preferable for the optical fiber 33 to use a multimode optical fiber such as a plastic optical fiber (POF: Polymer Optical Fiber) or a quartz glass optical fiber (GOF: Glass Optical Fiber). The POF has a core made of a plastic of excellent optical transparency such as PMMA or polycarbonate and has a clad made of a plastic whose refractive index is lower than that of the core. Moreover, the POF is allowed to have its core diameter easily increased to 200 μm or more in comparison with the GOF. Therefore, by using the POF, adjustment of coupling with the optical coupler 30 is facilitated, and manufacturing can be performed at low cost.

Moreover, it is acceptable to use PCF (Polymer Clad Fiber) in which the core is made of quartz glass and the clad is made of a polymer for the optical fiber 33. The PCF has features that it has a small transmission loss and a wide transmission band although it costs higher than the POF. Therefore, by using the PCF as a transmission medium, it becomes possible to constitute an optical communication network capable of carrying out long-distance communications and high-speed communications.

The thickness of the lead frame 36 ranges from about 100 μm to 500 μm. Then, a thin plate-shaped metal plate made of a metal that has electrical conductivity and high thermal conductivity is used for the lead frame 36. For example, copper, its alloy or an iron alloy such as 42 alloy in which about 42 percent of nickel is contained in iron is used. Moreover, the surface of the lead frame 36 may be plated with silver, gold, palladium or the like in order to improve corrosion resistance.

The optical coupler 30 having the above construction is manufactured as follows. First of all, the sealing body 37 is formed by making the drive circuit 39 adhere and electrically connect to the lead frame 36 and carrying out transfer molding. At this time, the upper surface side of the lead frame 36 is held by a metal mold, preventing the resin of the sealing body 37 from flowing to a portion where the optical element mounting portion 42 as well as the adhesive resin filling portion 59 on the upper surface side of the external connection portion 44 of the lead frame 36 are formed. Subsequently, the optical element 32 is made to adhere to the optical element mounting portion 42 and electrically connected via the bonding wire 40a, and the adhesive resin filling portion 59 is internally filled with the transparent adhesive resin 41 by means of a dispenser or the like. Next, the lens member 55 is inserted into the resin reservoir portion 58 and made to adhere to the optical element mounting portion 42 of the lead frame 36. In this stage, the lens member 55 and the optical element mounting portion 42 are aligned with each other in position by the resin reservoir portion 58 that has a planar shape roughly identical to the planar shape of the lens member 55. Moreover, in the present construction, the connector portion 35, which is constructed of the step portion in which the plug 34 of the optical fiber 33 is fit and performs positional alignment of the one end surface 33a of the fit optical fiber 33 with the lens portion 56, is formed at the periphery of the opening at the resin reservoir-portion 58. Therefore, the positional alignment of the optical fiber 33 and the positional alignment of the lens member 55 can be performed by an identical member, and high-accuracy simple assembling can be achieved. Then, by curing the transparent adhesive resin 41, the present optical coupler 30 is completed. It is noted that the curing of the transparent adhesive resin 41 is carried out by heating, ultraviolet ray irradiation or the like although it differs depending on the adhesive used.

### Second Embodiment

In an optical coupler 31 of the present embodiment, a through hole is provided at a lead frame, and an optical element is placed in the position of the through hole on the lower surface of the lead frame.

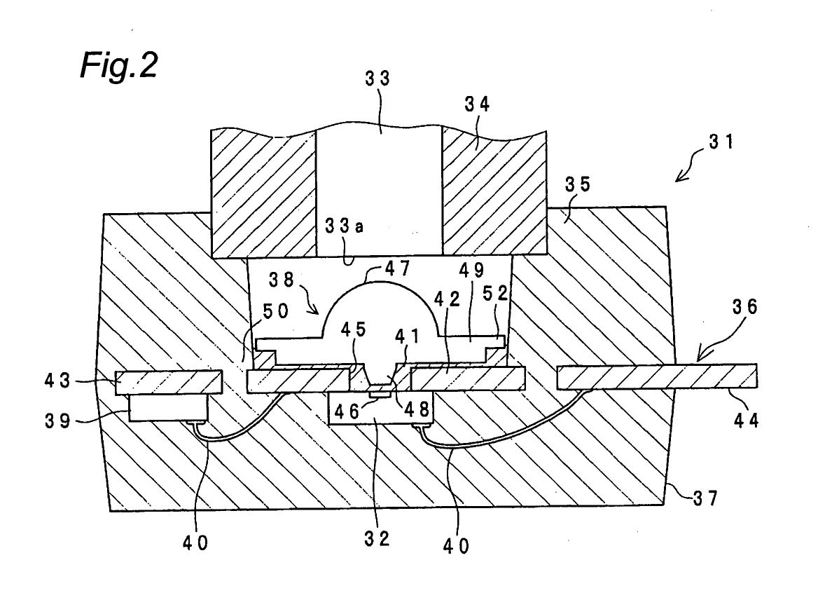

FIG. 2 is a longitudinal sectional view of the optical coupler 31 of the present embodiment. It is noted that the members having the same construction as that of the optical coupler 30 shown in FIG. 1 are denoted by the same reference numerals as those of FIG. 1, and no detailed description is provided for them.

In FIG. 2, a through hole 45 is formed at the optical element mounting portion 42 of the lead frame 36, and an optical element 32 is placed on the lower surface of the lead frame 36 so that its optical surface 46 is located at the center of the through hole 45. Then, the optical element 32 is electrically connected to an external connection portion 44 via a bonding wire 40.

A lens member 38 is placed facing the through hole 45 on the upper surface side of the optical element mounting portion 42 of the lead frame 36. The lens member 38 is constructed of a lens portion 47 that condenses light that is incident on and emitted from the optical surface 46 of the optical element 32, a projection 48 inserted in the through hole 45, and an adhesion portion 49 facing the upper surface of the lead frame 36. Then, a space between the projection 48 of the lens member 38 in the through hole 45 and the optical surface 46 of the optical element 32 is filled with a transparent adhesive resin 41. Thus, the transparent adhesive resin 41 is put in contact with the upper surface of the lead frame 36 and the optical surface 46 and also put in contact with the adhesion portion 49 and the projection 48 of the lens member 38. That is, the optical surface 46 of the optical element 32 and the lens member 38 adhere together via the transparent adhesive resin 41.

The through hole 45 of the lead frame 36 has the role of a lens barrel that fixes the lens member 38. As described above, by using the through hole 45 of the lead frame 36 as the lens barrel for fixing the lens member 38, a reduction in the parts count and a reduction in size become possible. Moreover, since the optical element 32 and the lens member 38 can be placed without interposition of the bonding wire 40, both the members can be placed adjacent to each other in terms of distance. Therefore, even when a light emitting element of a comparatively wide angle of radiation like an LED is used as the optical element 32, high light use efficiency can be achieved.

The optical element 32 has its periphery sealed (transfer molded) with the sealing body 37 excluding the optical surface 46. The sealing body 37 thus seals and protects the optical element 32, the drive circuit 39, the bonding wire 40 and so on. Moreover, the connector portion 35 described above is formed of the sealing body 37 in the present embodiment.

When the optical element 32 is a light emitting element, light emitted from the optical surface 46 of the light emitting element (optical element) 32 is made incident on the lens member 38 through the through hole 45. When the optical element 32 is a light receiving element, light emitted from the one end surface 33a of the optical fiber 33 is made incident on the lens member 38, condensed by the lens portion 47 through the through hole 45 and made incident on the optical surface 46 of the light receiving element (optical element) 32.

Also in the present embodiment, the lens member 38 is made to adhere to the lead frame 36 via the transparent adhesive resin 41. Therefore, the transparent adhesive resin 41 can be used as a member for buffering the thermal stress due to a linear expansion coefficient difference between the lead frame 36 and the lens member 38.

An effect of easing the thermal stress can be expected even if only the space between the adhesion portion 49 of the lens member 38 and the upper surface side of the lead frame 36 is filled with the transparent adhesive resin 41 instead of filling the through hole 45 with the resin. However, since the optical characteristics of the present optical coupler 31 change when the transparent adhesive resin 41 leaks to a part of the optical path, it becomes difficult to manufacture the optical coupler 31. In particular, the manufacturing becomes difficult when the lens member 38 is reduced in size. Furthermore, it becomes difficult to obtain an effect of improving the optical characteristics (improvement in the external extraction efficiency and reduction in reflectance) due to the covering of the optical surface 46 and an effect of sealing the optical element 32 from the outside air. In contrast to this, when the through hole 45 is internally filled with the transparent adhesive resin 41 as in the present embodiment, moisture and impurities can be prevented from adhering to the optical surface 46, and the moisture resistance of the optical coupler 31 can be improved. Therefore, it is preferable to fill the through hole 45 with the transparent adhesive resin 41 from the viewpoint of protection of the optical element 32 and stabilization of the optical characteristics.

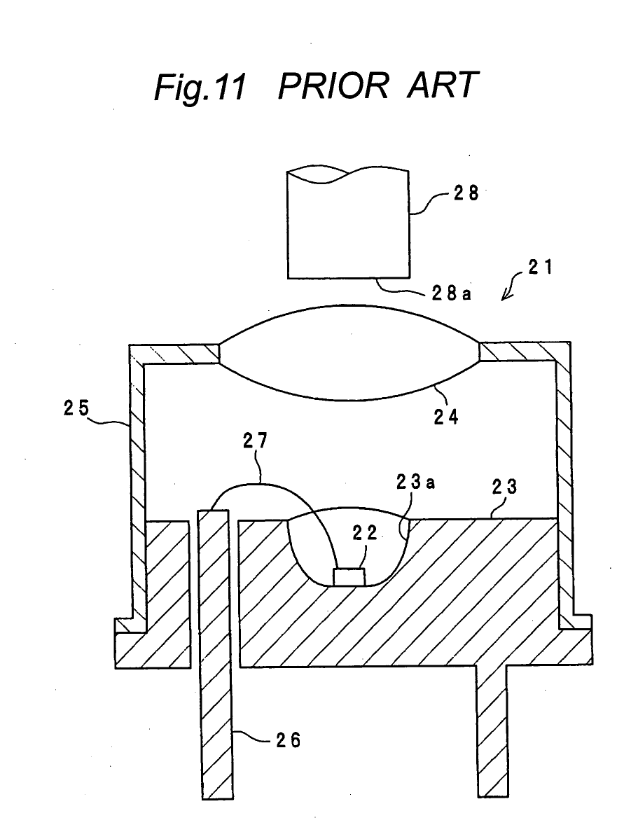

Moreover, by comparison to the optical coupler 21 (see FIG. 11) of the third prior art, the optical coupler 31, which can utilize the thin plate-shaped lead frame 36 as the lens barrel, costs less and facilitates the reductions in the parts count and the size. Further, the formation of the through hole 45 of the lead frame 36 has the advantage that the formation can be performed concurrently with the formation of other patterns of the lead frame 36 by press working and etching resulting in cost reduction.

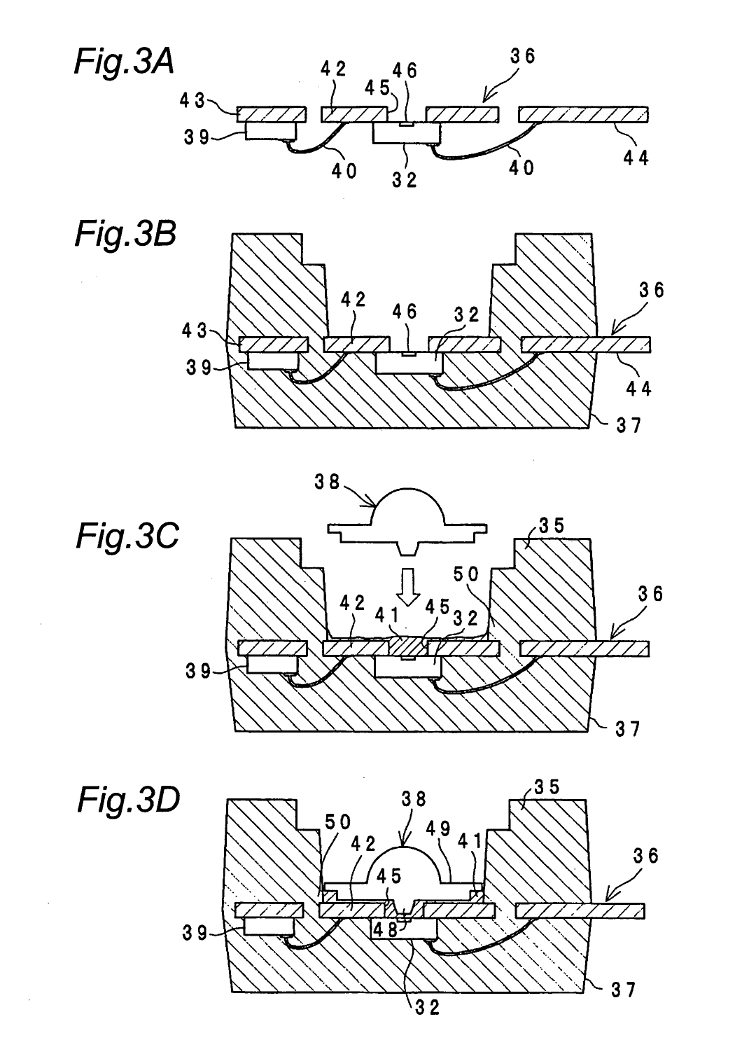

A method for producing the present optical coupler 31 is described next with reference to FIGS. 3A through 3D. First of all, as shown in FIG. 3A, the optical element 32 and the drive circuit 39 is made to adhere to the lead frame 36 by performing positional alignment, and the lead frame 36 is electrically connected to a lower surface electrode (not shown) of the optical element 32 and the drive circuit 39 via the bonding wires 40.

In the case, a conductive material of an Ag paste, solder, gold eutectic bonding or the like as an adhesive is used to perform adhesion so that the electrode formed on the optical surface 46 side of the optical element 32 is electrically connected to the lead frame 36. Otherwise, when no electrical connection is needed, a transparent adhesive having no conductivity may be used. When the transparent adhesive is used, the deterioration of the optical characteristics due to the adhesion of the adhesive to the optical surface 46 can be prevented, and this is particularly preferable when a small-size optical element 32 is used as in an LED or PD. In this case, when the adhesive adheres to the optical surface 46 even if it is normally a transparent adhesive, the optical characteristics disadvantageously change as a consequence of a change in the refractive index of the optical surface 46. However, since the inside of the through hole 45 is subsequently filled with the transparent adhesive resin 41, the present embodiment has the advantage that no change occurs in the optical characteristics if the refractive index of the transparent adhesive resin 41 and the refractive index of the adhesive for the adhesion of the optical element 32 are set equivalent to each other.

Next, as shown in FIG. 3B, the sealing body 37 is formed by carrying out transfer molding. At this time, the surface side of the lead frame 36 is held by the metal mold, preventing the resin of the sealing body 37 from flowing to the portion to which the lens member 38 on the surface side of the optical element mounting portion 42 of the lead frame 36 adhere.

Next, as shown in FIG. 3C, the through hole 45 of the optical element mounting portion 42 is internally filled with the transparent adhesive resin 41 by means of a dispenser or the like. It is preferable to form a resin reservoir portion 50 at a lower portion of the connector portion 35 of the sealing body 37. The resin reservoir portion 50 is constructed of a recess, which has a planar shape roughly identical to the planar shape of the lens member 38 and in which the lens member 38 is accommodated. Then, the resin reservoir portion 50 plays the role of preventing the liquid transparent adhesive resin 41 put in the through hole 45 of the lead frame 36 from overflowing from the through hole 45 and from flowing to the outside beyond the region of the lens member 38 and preventing the lens member 38 from coming in contact with the lead frame 36 by floating the lens member 38 from the upper surface of the lead frame 36 by the transparent adhesive resin 41. It is also acceptable to adjust the amount of the transparent adhesive resin 41 to prevent the resin from overflowing from the through hole 45. However, if the amount of the transparent adhesive resin 41 is small, there is a problem that the transparent adhesive resin 41 slips out of a gap between the lens member 38 and the lead frame 36 due to a capillary phenomenon when the lens member 38 is placed, failing in completely fill the inside of the through hole 45 with the transparent adhesive resin 41 (air bubbles enter) and so on.

Next, as shown in FIG. 3D, the projection 48 of the lens member 38 is inserted in the through hole 45, and the lens member 38 is made to adhere to the optical element mounting portion 42 of the lead frame 36. The resin reservoir portion 50 can be utilized for the positional alignment of the lens member 38 with the optical element mounting portion 42. That is, the positional alignment can be achieved by making the resin reservoir portion 50 have a planar shape roughly identical to the planar shape of the lens member 38 and making the inside diameter of the resin reservoir portion 50 roughly equivalent to the outside diameter of the adhesion portion 49 of the lens member 38.

By inserting the projection 48 of the lens member 38 into the through hole 45, part of the transparent adhesive resin 41 put in the through hole 45 is pushed out by the projection 48 of the lens member 38 to overflow from the through hole 45 toward the upper surface side of the optical element mounting portion 42 and is stored in the resin reservoir portion 50 of the sealing body 37. As a result, in a state in which the lens member 38 is placed in the place of the optical element mounting portion 42, a space between the lens member 38 (adhesion portion 49) and the surface of the optical element mounting portion 42 is filled with the transparent adhesive resin 41 as shown in FIG. 3D. Moreover, a state in which the periphery of the projection 48 is filled with the transparent adhesive resin 41 results. Then, the present optical coupler 31 is completed by curing the transparent adhesive resin 41. It is noted that the curing of the transparent adhesive resin 41 is carried out by heating, ultraviolet ray irradiation or the like although it differs depending on the adhesive used.

As shown in FIG. 2, the projection 48 of the lens member 38 has a so-called taper shape of which the dimension in the direction perpendicular to the optical axis of the lens portion 47 (dimension in the horizontal direction of FIG. 2) is reduced toward the tip end. This arrangement allows the uniform adhesion of the lens member 38 with the transparent adhesive resin 41 by making the transparent adhesive resin 41 continuously overflow from the through hole 45. Moreover, there is also an effect of preventing air bubbles from entering the through hole 45. That is, even if air bubbles are involved in the through hole 45 when the lens member 38 is placed, the air bubbles can be discharged to the outside together with the outflowing transparent adhesive resin 41. The taper shape of the projection 48 is optimized to an arbitrary shape and a size in conformity to the amount of the outflowing transparent adhesive resin 41.

Further, the projection 48 also has the operation of reducing the amount (volume) of the transparent adhesive resin 41 put in the through hole 45. Since the amount of volume variation due to thermal contraction is reduced by the reduction in the volume of the transparent adhesive resin 41, thermal stress can be made to influence less. Further, since the adhesion area of the lens member 38 with the transparent adhesive resin 41 is increased by the formation of the projection 48, there is a further effect that the adhesive strength of the lens member 38 to the lead frame 36 is improved.

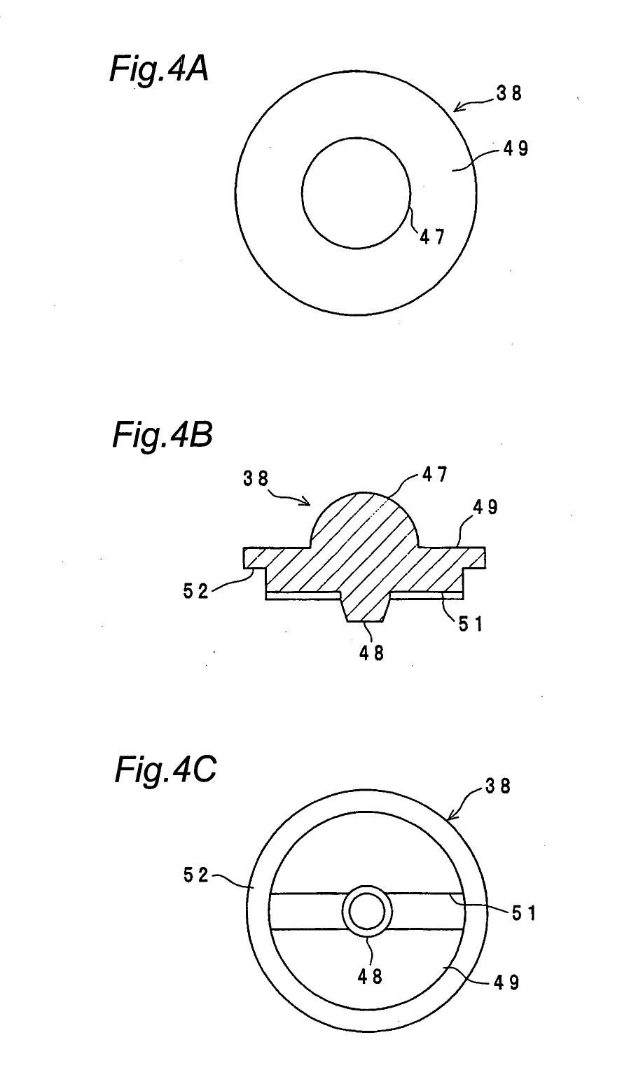

As described above, in the case of the construction in which the through hole 45 is filled with the transparent adhesive resin 41 as in the present optical coupler 31, it is important to devise the shape of the lens member 38 so that no air bubble enters the transparent adhesive resin 41 during the manufacturing (at the time of adhesion of the lens member 38). The desirable shape of the lens member 38 is described here with reference to FIGS. 4A through 4C.

FIGS. 4A through 4C show one example of the shape of the lens member 38. FIG. 4A is a plan view of the lens member 38 viewed from the lens portion 47 side, FIG. 4B is a longitudinal sectional view, and FIG. 4C is a bottom view viewed from the optical element 32 side. The adhesion portion 49 has a flat surface facing the lead frame 36, and the projection 48 has an operation of a stopper (keeping constant a distance to the surface of the optical element mounting portion 42) when the projection 48 is inserted in the through hole 45. Moreover, the lens member 38 should desirably be formed by injection molding of an inexpensive method, and the adhesion portion 49 has an operation as a gate portion and an ejector pin receiving portion during the injection molding. Further, it is preferable to form a resin outflow portion (groove portion) 51 that extends in the radial direction from the projection 48 on the surface of the adhesion portion 49 facing the lead frame 36. The resin outflow portion 51 has the role of discharging the transparent adhesive resin 41 that outflows when the projection 48 is inserted in the through hole 45 toward the resin reservoir portion 50. By forming the resin outflow portion 51, the transparent adhesive resin 41 is formed more uniformly, and the entry of air bubbles can more reliably be prevented. It is noted that the resin outflow portion 51 can efficiently discharge the transparent adhesive resin 41 that includes air bubbles pushed out of the inside of the through hole 45 by forming the resin outflow portion 51 connectively with the projection 48, and this is preferable.

Moreover, it is preferable to form an eaves-shaped resin holding portion 52 on an upper portion of the outer periphery of the adhesion portion 49 of the lens member 38. The resin holding portion 52 has a function to prevent the liquid transparent adhesive resin 41 from flowing toward the upper surface side (lens portion 47 side) of the lens member 38, preventing the transparent adhesive resin 41 from adhering to the lens portion 47 for the prevention of a change in the characteristics.

The viscosity of the transparent adhesive resin 41 should preferably be set to 10 Pa·s or less so that no air bubble enter during injection into the through hole 45. Moreover, a material that has a linear expansion coefficient close to that of the optical element (Si or GaAs) 32 and the bonding wire (Au or Al) 40 and high thermal conductivity is used for the sealing body 37. For example, when the optical element 32 and the bonding wire 40 have an Si linear expansion coefficient of 2.8 ppm/K and an Au linear expansion coefficient of 14.2 ppm/K, the linear expansion coefficient of the sealing body 37 should preferably be set to 20 ppm/K or less (linear expansion coefficient of epoxy based resin to which no filler is added is normally about 60 ppm/K).

Results of conducting a temperature cycling test by means of the present optical coupler 31 are described next. Comparative testing was conducted also by means of the optical couplers 1, 11 of the first and second prior arts (see FIGS. 9 and 10) for the sake of comparison.

The following four kinds of samples were prepared. Then, the conditions of the temperature cycling were set to −40° C. on the low temperature side and to 115° C. on the high temperature side, and the exposure time at each temperature was set to 15 minutes. The number of cycles was set to 3000 cycles, and the state was confirmed every 100 cycles.

Sample A: The present optical coupler 31 shown in FIG. 2 using a silicon based resin as the transparent adhesive resin 41.

Sample B: The present optical coupler 31 shown in FIG. 2 using an epoxy based resin as the transparent adhesive resin 41.

Sample C: The optical coupler 1 of the first prior art shown in FIG. 9.

Sample D: The optical coupler 11 of the second prior art shown in FIG. 10.

The common members used were an LED of a wavelength of 650 nm (emission diameter: φ150 μm) as the light emitting elements 32, 3, 12, a copper alloy of a thickness of 250 μm (linear expansion coefficient: 17 ppm/K) as the lead frames 36, 2, 13, and gold of a wire diameter of 25 μm as the bonding wires 40, 8, 18. Moreover, members peculiar to each of the samples used were polycarbonate of the lens member 38, an epoxy based filler-added resin (linear expansion coefficient: 18 ppm/K) of the sealing body 37, and an epoxy based resin to which no filler is added (linear expansion coefficient: 65 ppm/K) of the transparent mold resins 4, 16. Moreover, a silicon based resin (Young's modulus: 1 MPa) was used as the transparent adhesive resin 41 in Sample A, and an epoxy based resin (Young's modulus: 3 GPa) was used in Sample B.

When temperature cycling tests were conducted on the above conditions, defects occurred within 300 cycles in Sample C and Sample D. That is, cracks were generated in the transparent mold resin 4, and the defect of the breakage of the bonding wire 8 occurred in Sample C. Moreover, samples in which the quantity of incident light (quantity of transmitted light) on the optical fiber 14 was reduced by about 50% were observed in Sample D in addition to the similar defect described above. This can presumably be ascribed to the fact that the transparent mold resin 16 has been peeled off the optical surface 17 due to a thermal stress and the optical extraction efficiency of the LED (optical element) 12 has been reduced by half.

On the other hand, in Sample A, the variation in the quantity of the transmitted light was within ±10% also after 3000 cycles, and neither the deformation nor the damage of the lens member 38 occurred. Moreover, although samples in which the quantity of the transmitted light was reduced by about 20% were included in Sample B, no other problem occurred. In Sample B, it is considered that the transparent adhesive resin 41 has been partially peeled off the optical surface 46 due to a thermal stress because of the use of the epoxy based resin of a high Young's modulus as the transparent adhesive resin 41.

As described above, in contrast to the fact that cracks occurred in the transparent mold resins 4, 16 and the quantity of the transmitted light was reduced by half by the temperature cycling test due to the influence of the thermal stress in the optical couplers 1, 11 of the first and second prior arts, no such defects occurred in the optical coupler 31 of the present embodiment. In particular, it was proved that the effect was remarkably produced when the silicon based resin of a low Young's modulus was used as the transparent adhesive resin 41.

In this case, when a shearing stress (at −40° C.) exerted on the adhesion surface of the optical element 32 (surface: SiO₂) to the transparent adhesive resin 41 was obtained through simulation by a finite element method, the stress was 66 MPa in the case of the epoxy based resin (Young's modulus: 3 GPa, linear expansion coefficient: 70 ppm/K) used in Sample B. On the other hand, when the adhesive strength (shear adhesive strength) of the optical element 32 with respect to the transparent adhesive resin 41 was measured, the strength was 40 MPa in the case of the epoxy based resin used in Sample B, meaning that the shearing stress due to heat was larger than the adhesive strength. On the other hand, when calculation was performed with an epoxy based resin of a lower Young's modulus (Young's modulus: 1 GPa, linear expansion coefficient: 70 ppm/K), the shearing stress was 22 MPa, meaning that the adhesive strength was higher. When the temperature cycling test described above was conducted by using the latter resin, the variation in the quantity of transmitted light became within ±10% equivalent to the case of the silicon based resin. For the above reasons, it is preferable to use a resin of a Young's modulus of not greater than 1 GPa having a high stress easing effect as the transparent adhesive resin 41. In particular, the silicon based resin is more preferable since it has a low Young's modulus and also has an effect of sealing the optical element 32.

It is a matter of course that the problems as described above do not occur if the temperature range is narrowed (e.g., about −20° C. to 80° C.) also in the optical couplers 1, 11 of the first and second prior arts. That is, by using the optical coupler 31 of the present embodiment, the optical coupler can be used in a wider temperature range.

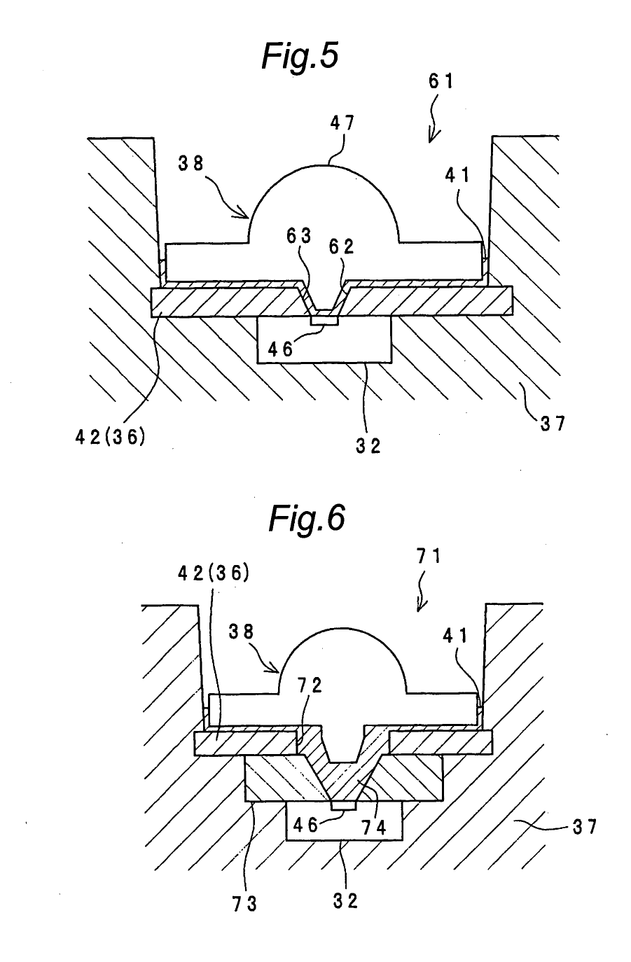

A modification example of the optical coupler of the present embodiment described above is described below with reference to FIGS. 5 through 8. It is noted that the same members that have the same construction as the construction of the optical coupler 31 shown in FIG. 2 are denoted by the same reference numerals, and no detailed description is provided for them. It is noted that FIGS. 5 through 8 are schematic views for explaining the essential points of the construction different from the construction of the optical coupler 31 shown in FIG. 2, and the members other than the optical element 32, the lens member 38, the optical element mounting portion 42 of the lead frame 36, the transparent adhesive resin 41, the sealing body 37 and the members corresponding to them are not shown.

In an optical coupler 61 shown in FIG. 5, a through hole 62 located in the optical element mounting portion 42 of the lead frame 36 is formed into a taper shape such that the side on which the optical element 32 is placed is has a smaller diameter (approximately equal to the size of the optical surface 46). In the above construction, an inner peripheral surface 63 of the through hole 62 is used as a reflection mirror. In this case, when a light emitting element of an LED or the like is used as the optical element 32, light of a narrow angle of radiation among lights emitted from the light emitting element 32 is made directly incident on the lens portion 47 through the through hole 62, refracted and incident on the optical fiber 33. On the other hand, light of a wide angle of radiation among lights emitted from the light emitting element 32 is reflected on the taper portion (inner peripheral surface 63) of the through hole 62, thereafter made incident on the lens portion 47, refracted and made incident on the optical fiber 33. Therefore, the light emitted from the optical element 32 can be made incident on the optical fiber 33 with high efficiency even when an LED of a wide angle of radiation or the like is used as the optical element 32.

Moreover, also when a light receiving element such as a PD is used as the optical element 32, a high light condensing effect can be obtained by reflecting the incident light on the taper portion (inner peripheral surface 63) of the through hole 62. It is noted that the through hole 62 can be concurrently formed during the patterning of the lead frame 36 by etching, press working and so on, and therefore, an inexpensive optical coupler 61 can be obtained without increasing the cost.

In an optical coupler 71 shown in FIG. 6, a submount 73 is interposed between a through hole 72 in the optical element mounting portion 42 of the lead frame 36 and the optical element 32. In the above construction, an optical passage portion 74 is formed at the submount 73. The optical passage portion 74 is constructed of a hole that penetrates in the thickness direction of the submount constituted by filling the hole with an optically transparent material. Moreover, the optical element 32 is made to adhere to the submount 73. Then, it is also possible to form an electrode (not shown) electrically connected to the electrode (not shown) of the optical element 32 on the submount 73 and to electrically connect the electrode to the lead frame 36 or the driver circuit 39 via a bonding wire (not shown). It is noted that the through hole 72 of the lead frame 36 is formed to have a diameter larger than the major diameter portion of the optical passage portion 74 of the submount 73. Moreover, since the lead frame 36 and the submount 73 are not necessarily electrically connected together, they can be made to adhere together with an arbitrary adhesive.

An Si board, a glass board or the like can be employed as the submount 73. For example, when the Si board is employed, it is preferable to use a through hole obtained by processing a single crystal Si board by anisotropic etching as the optical passage portion 74. For example, by etching the (100) plane of the single crystal Si with KOH (potassium hydroxide), a (111) plane having an angle of 54.74° can be obtained as a smooth surface that has an accurate angle. In this case, processing accuracy and profile irregularity are better than when the through hole 62 of the lead frame 36 is processed into a taper shape as in the case of the optical coupler 61 shown in FIG. 5, and a high performance can be obtained as a reflection mirror. Furthermore, Si has a high thermal conductivity, and there is no linear expansion coefficient difference between the submount (Si board) 73 and the optical element 32 when Si is used as the optical element 32, making it possible to reduce the stress and thermal resistance of the optical element 32.

Moreover, a glass board may be used as the submount 73. Since the glass board is optically transparent, there is no need to form a through hole as the optical passage portion 74. Furthermore, Pyrex glass and the like have a linear expansion coefficient close to that of Si (optical element 32), and the stress to the optical element 32 can be reduced by selecting the kind of the glass. Furthermore, it is also possible to form a convex lens or a Fresnel lens at the optical passage portion 74 and to condense the incident light and outgoing light.

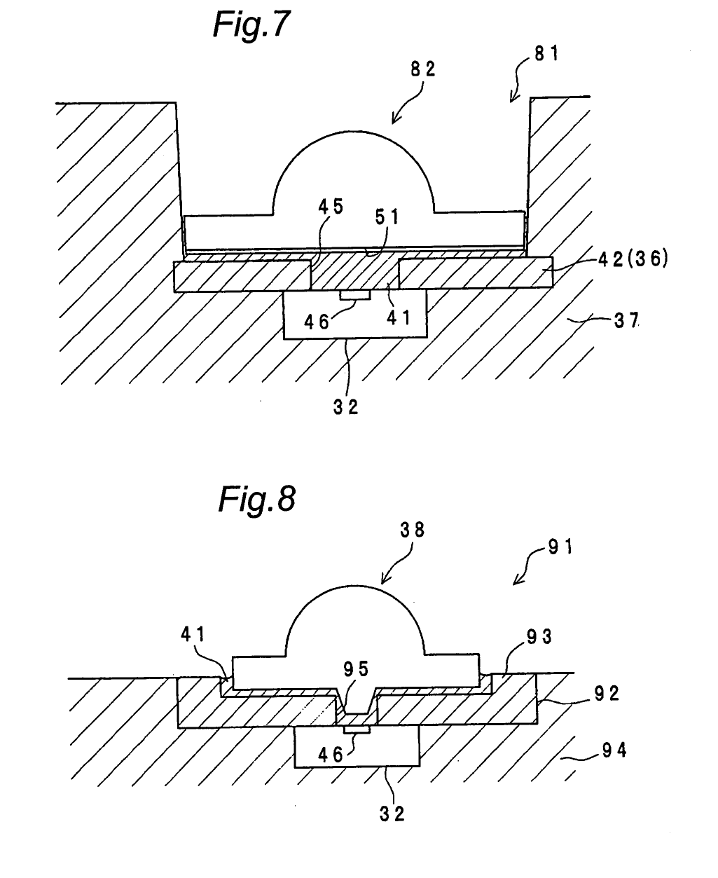

In an optical coupler 81 shown in FIG. 7, a lens member 82 that has no projection corresponding to the projection 48 formed at the lens member 38 of the optical coupler 31 shown in FIG. 2 is employed. For example, a transparent adhesive resin 41 of a low viscosity (not greater than 0.1 Pa·s) is used in the above construction, the flowability of the transparent adhesive resin 41 is high, and air bubbles are easily discharged. Therefore, the generation of air bubbles can be suppressed only by forming a resin outflow portion (groove portion) 51 without forming the projection on the lens member 82, and the lens member 82 can easily be formed.

In an optical coupler 91 shown in FIG. 8, a resin reservoir portion 93 is formed not at a sealing body 94 but on a lead frame 92. In the above construction, the resin reservoir portion 93 is provided by forming a recess that has a planar shape roughly identical to the planar shape of the lens member 38 on the surface of the peripheral portion of a through hole 95 at the lead frame 92. For example, when the connector portion 35 (see FIG. 2) is not formed of the sealing body 94 or in a similar case, the optical coupler 91 can be reduced in thickness by not forming the sealing body 94 on the surface side of the lead frame 92. In such a case, a function similar to that of the resin reservoir portion 50 of the optical couplers 31, 61, 71, 81 can be obtained by forming the resin reservoir portion 93 at the lead frame 92.

As described above, according to the optical couplers 30, 31, 61, 71, 81, 91 of the present embodiment, the thermal stress generated in the lens members 55, 38, 82 can be reduced, and sealing with the sealing bodies 37, 94 to which the filler is added can be achieved. Therefore, it becomes possible to use the optical coupler under an environment in a wide temperature range of, for example, −40° C. to 115° C. Furthermore, the lead frames 36, 92 can be utilized as the lens barrels for fixing the lens members 38, 82, and the compact inexpensive optical couplers 31, 61, 71, 81, 91 can be obtained with the parts count reduced. Furthermore, by devising the shapes of the lens members 38, 82, the optical couplers 31, 61, 71, 81, 91 capable of obtaining stable performances free from the inclusion of air bubbles can be obtained.

1. An optical coupler comprising:
an optical element (32);
a lead frame (36, 92) on which the optical element (32) is mounted and which is electrically connected to the optical element (32); and
a lens member (38, 55, 82) including a lens (47, 56) that condenses light that is incident on or emitted from the optical element (32), wherein
the lens (47, 56) of the lens member (38, 55, 82) is placed facing an optical surface (46), on or from which light is incident or emitted, of the optical element (32), and
a transparent resin (41) is interposed between the lens member (38, 55, 82) and the optical surface (46) of the optical element (32).

2. The optical coupler as claimed in claim 1, wherein
the transparent resin (41) also extends over a surface of the lead frame (36, 92) located on a side on which the lens member (38, 55, 82) is placed, and
the lens member (38, 55, 82) is made to adhere to the lead frame (36, 92) via the transparent resin (41) that extends over the surface of the lead frame (36, 92) and is not put in direct contact with the lead frame (36, 92).

3. The optical coupler as claimed in claim 1, wherein
the transparent resin (41) has a Young's modulus of not greater than 1 GPa.

4. The optical coupler as claimed in claim 1, wherein
the transparent resin (41) is a silicon based compound.

5. The optical coupler as claimed in claim 1, wherein
a portion excluding at least the lens member (38, 55, 82) and the transparent resin (41) is sealed with a filler-added resin (37, 94).

6. The optical coupler as claimed in claim 5, wherein
a resin reservoir portion (50, 58, 93), which prevents the transparent resin (41) put in between the lens member (38, 55, 82) and the optical surface (46) of the optical element (32) from expanding beyond a region of the lens member (38, 55, 82), is provided at the filler-added resin (37, 94).

7. The optical coupler as claimed in claim 6, wherein
the resin reservoir portion (50, 58, 93) is comprised of a recess, which has a planar shape roughly identical to a planar shape of the lens member (38, 55, 82) and in which the lens member (38, 55, 82) is accommodated, and
a connector portion (35), in which a tip end portion of an optical fiber (33) for transmitting light that is incident on or emitted from the optical element (32) is fit and which performs positional alignment between the tip end portion of the fit optical fiber (33) and the lens member (38, 55, 82) is provided at a periphery of an opening of the resin reservoir portion (50, 58, 93).

8. The optical coupler as claimed in claim 1, wherein
a through hole (45, 62, 72, 95) is formed at the lead frame (36, 92),
the optical element (32) is placed so that the optical surface (46) is located in the through hole (45, 62, 72, 95) formed at the lead frame (36, 92), and one opening of the through hole (45, 62, 72, 95) is closed,
the lens member (38, 55, 82) is placed so that an optical axis of the lens (47, 56) penetrates inside of the through hole (45, 62, 72, 95) formed at the lead frame (36, 92), and the other opening of the through hole (45, 62, 72, 95) is closed, and
the through hole (45, 62, 72, 95) is filled with the transparent resin (41).

9. The optical coupler as claimed in claim 8, wherein
a projection (48), which is inserted in the through hole (45, 62, 72, 95) of the lead frame (36, 92) when placed so that the lens member (38) is located to close the other opening of the through hole (45, 62, 72, 95) of the lead frame (36, 92), is provided on a surface, which faces the lead frame (36, 92), of the lens member (38).

10. The optical coupler as claimed in claim 9, wherein
the projection (48) of the lens member (38) has a taper shape whose dimension in a direction perpendicular to the optical axis is reduced toward the tip end.

11. The optical coupler as claimed in claim 8, wherein
a groove portion (51), which communicates with the through hole (45, 62, 72, 95) of the lead frame (36, 92) and the outside is provided on a surface, which faces the lead frame (36, 92), of the lens member (38, 82).

12. The optical coupler as claimed in claim 8, wherein
an inner peripheral surface (63) of the through hole (62) of the lead frame (36) is a reflecting surface for reflecting light that is incident on or emitted from the optical element (32).
